(19) United States
(12) Patent Application Publication
(10) Pub. No.: US 2009/0044631 A1
(43) Pub. Date: Feb. 19, 2009

(54) Illuminated Liquid Filled Gauge

(76) Inventor: John Neighoff, JR., Harmony, PA (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/104,577

(22) Filed: Apr. 17, 2008

Related U.S. Application Data
(60) Provisional application No. 60/913,055, filed on Apr. 20, 2007.

(51) Int. Cl. G01L 19/06; G01D 11/28

(52) U.S. Cl. 73/738; 362/23

(57) ABSTRACT

A liquid filled gauge for measuring, for example, pressure, includes a gauge housing, a lens cap attached to the housing, a gauge diagnostic element contained at least partially within the housing, a dial that includes a translucent portion and a non-translucent portion and an electroluminescent device positioned adjacent the dial for transmitting light through said translucent portion and illuminating said dial. The dial is operatively connected to the gauge diagnostic element. A protective cover may be provided for sealing the electroluminescent device and protecting the electroluminescent device from the liquid which fills the gauge housing.

### CROSS REFERENCE TO RELATED APPLICATION

This application claims the benefit of U.S. Provisional Application No. 60/913,055 filed Apr. 20, 2007, the contents of which are hereby incorporated by reference.

### FIELD OF THE INVENTION

The present invention relates to gauges, and more particularly relates to illuminated liquid filled gauges.

### BACKGROUND

Various types of industrial diagnostic gauges are known for measuring, for example, the temperature or pressure of liquids or gases. Although the present invention is suitable for use with both temperature and pressure gauges, for purposes of illustration, this description principally concentrates on pressure gauges. One example of a specific type of pressure gauge is a Bourdon tube pressure gauge. Bourdon tube pressure gauges are widely used to measure the pressure of fluids. Such gauges work on the principle that pressure in a curved tube will tend to straighten it. When pressure is applied to the inner space of the tube, the tube will straighten out until the difference in force exerted by the fluid inside the tube is balanced by the elastic resistance of the material composing the tube. It is well known in the art to couple a rotatable pointer to the free end of the tube through a suitable transmission mechanism. Hence, as the Bourdon tube straightens out under increasing pressure, the pointer is proportionally turned. Pressure may be read off of a scale that is suitably aligned with the pointer.

Bourdon gauges are often used in highly corrosive atmospheres and in locations where severe vibrations or pressure pulsations or both are present. Under such circumstances, it is well known to fill these gauges with a viscous liquid such as mineral oil or glycerin. The liquid will act as a damper to counteract the vibrations and pressure pulsations and as a lubricant for the moving parts of the pointer mechanism and will isolate the interior of the gauge from corrosive atmospheres. Due to the presence of the liquid inside the gauge as well as fluid which pressurizes the inner space of the Bourdon tube, it is desirable to have a well sealed gauge in order to prevent the leakage of any dampening liquid or pressurized measured fluid.

Industrial diagnostic gauges are required in numerous industrial applications. Many of these applications require the gauges to be placed in locations that are difficult for a person to access. For example, a gauge may be located in a radioactive or other hazardous location, e.g., nuclear power plants, biohazard laboratories; disposed high above the ground, e.g., on a tower of a petrochemical plant; located in close proximity to moving parts of a machine, or any other location that restricts a person desiring to read the gauge from safely and easily approaching the gauge.

The necessity of a person attempting to read the gauge to get as close as possible to the gauge is increased during times when little or no light is present, e.g., at night, when overhead lighting, either natural, e.g., sunlight, or artificial light, is unavailable, or when the gauges are placed in obstructed areas. Generally, a gauge cannot be accurately read at distances greater than about four feet when little or no light is present. Under these conditions, the person must take special precautions to approach the gauge, e.g., put on special clothing to enter radioactive areas or read the gauges in inclement weather; or climb ladders to reach the gauge disposed high above the ground.

Prior attempts to address the problem of reading diagnostic gauges in low or no light have been directed at adding either external lighting or internal lighting to the gauge. External lighting requires leaving overhead lights on at all times or placing additional lighting focused on the gauge. Internal lighting requires wiring the gauge with electrical circuitry and/or batteries, to illuminate the diagnostic dial, or face. Both of these approaches increase the cost of the gauge and/or the construction and maintenance of the additional wiring and equipment.

Liquid filled pressure gauges provide advantages over dry gauges, but they are more difficult to illuminate, particularly in Bourdon tube assemblies which block rear light sources. Attempts have been made to light such gauges with incandescent light bulbs or a ring of light around the periphery of the gauge dial. However, such designs do not fully or uniformly light the dials of liquid filled pressure gauges, and do not provide for optimal reading or appearance of the gauges.

The present invention has been developed in view of the foregoing.

### SUMMARY

An aspect of the present invention is to provide a liquid filled gauge comprising a housing, a lens cap attached to the housing, and a gauge diagnostic element contained at least partially within the housing. The dial includes a translucent portion and a non-translucent portion. The dial is operatively connected to the gauge diagnostic element. The liquid filled gauge also comprises an electroluminescent device positioned adjacent the dial for transmitting light through the translucent portion and illuminating the dial. The gauge may also comprise a protective cover for enclosing the electroluminescent device to seal and protect the electroluminescent device from the liquid that fills the gauge. In one embodiment, the protective cover may include first and second laminate sheets on opposing faces of the electroluminescent device. In addition, the liquid filled gauge may comprise the dial having a display face, also referred to as a dial face, with a first area with analog markings and a second area without analog markings along with a pointer movably aligned with the analog markings. The first area with analog markings may make up the non-translucent portion of the dial while the second area without analog markings may make up the translucent portion of the dial. Furthermore, the gauge diagnostic element may be utilized for measuring pressure.

Another aspect of the present invention is to provide an apparatus comprising a sealed housing containing a liquid and a gauge diagnostic element contained in the housing. The apparatus also comprises a dial that is operatively connected to the gauge diagnostic element and the dial is visibly positioned within the sealed housing. The apparatus further comprises an electroluminescent device positioned adjacent the dial for illuminating at least a portion of the dial.

A further aspect of the present invention is to provide a liquid filled pressure gauge comprising a gauge housing, a gauge lens attached to the gauge housing in order to seal the liquid within the gauge housing, a gauge diagnostic system contained within the gauge housing for measuring and displaying a pressure measurement, and an electroluminescent lamp assembly positioned adjacent the gauge diagnostic system for illuminating the displayed pressure measurement.

These and various other features and advantages will be apparent from a reading of the following detailed description.

### DRAWINGS

FIG. 1 is an exploded isometric view showing the components of a backlit liquid filled pressure gauge in accordance with an embodiment of the present invention.

FIG. 2 is an isometric sectional view of the backlit liquid filled pressure gauge shown in FIG. 1, with the gauge in an assembled condition.

FIG. 3 is a side sectional view of the assembled backlit liquid filled pressure gauge of FIG. 2.

### DETAILED DESCRIPTION

The present invention relates generally to gauges, and more particularly relates generally to illuminated liquid filled gauges. The present invention is suitable for use with, for example, temperature and pressure gauges but is not limited to any particular type of gauge. For purposes of illustration only, the description set forth herein generally concentrates on liquid filled pressure gauges. The liquid filled pressure gauge that may utilize aspects of the present invention may be, for example, a Bourdon tube type liquid filled pressure gauge. Such liquid filled pressure gauges are generally known (see, for example, U.S. Pat. Nos. 4,192,193 and 4,627,285) and the invention may incorporate basic known components such as, for example, gauge diagnostic components for measuring pressure as is generally known.

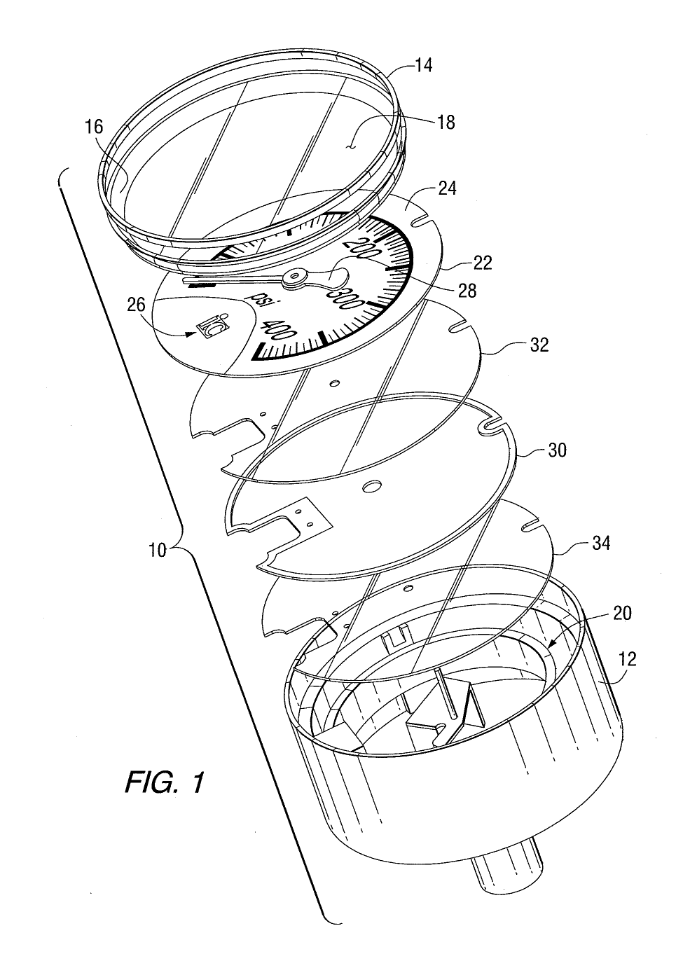

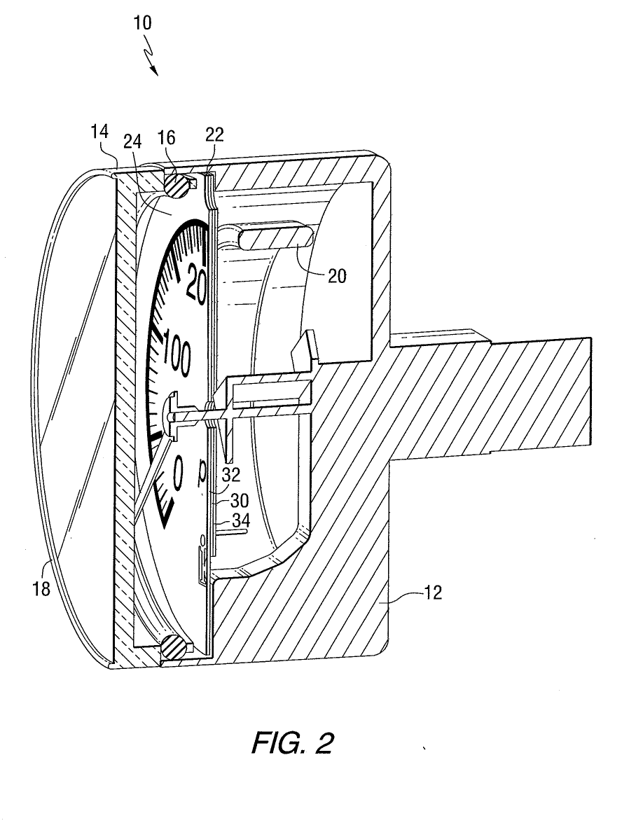

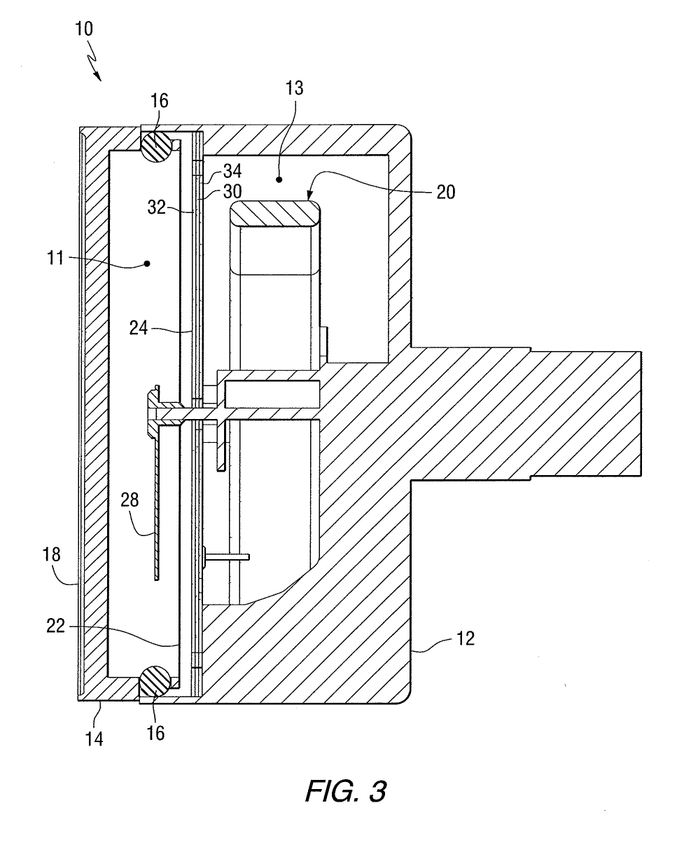

Referring to FIGS. 1, 2 and 3, there is illustrated an illuminated (which also may generally be referred to as backlit, but the invention is not limited to backlighting only) liquid filled pressure gauge, generally referred to by reference number 10, in accordance with an embodiment(s) of the present invention. FIG. 1 is an exploded isometric view showing the components of a backlit liquid filled pressure gauge in accordance with an embodiment of the present invention. FIG. 2 is an isometric sectional view of the backlit liquid filled pressure gauge shown in FIG. 1, with the gauge in an assembled condition. FIG. 3 is a side sectional view of the assembled backlit liquid filled pressure gauge of FIG. 2.

As illustrated in FIGS. 1, 2 and/or 3, the illuminated liquid filled pressure gauge 10 can include a housing 12 and a lens cap 14 that attaches to the housing 12. The lens cap can include an elastomeric or rubber gasket 16 that extends circumferentially around the periphery thereof in order to seal a liquid within the gauge housing 12 in order to provide the liquid filled pressure gauge 10. The liquid may be contained in a front liquid chamber 11 and a back liquid chamber 13 (see FIG. 3), or otherwise contained as is generally known for liquid filled gauges. The lens cap 14 and, more specifically the rubber gasket 16 thereof, can attach to the housing 12 by a friction fit therebetween or by any other generally known means for connecting a lens cap to a pressure gauge housing such as, for example, using an epoxy material for providing the liquid seal between the lens cap 14 and the housing 12. In addition, the lens cap 14 includes a face cover 18 that is transparent in order to allow a user of the gauge 10 to view the measurement markings within the gauge 10, as will be described herein.

The illuminated liquid filled pressure gauge 10 also includes a gauge diagnostic element, generally referred to by reference number 20, contained at least partially within the housing 12 and operatively connected to a dial 22 that cooperates with the gauge diagnostic element 20 for measuring and displaying a measurement such as, for example, a pressure measurement. The dial 22 includes a front display face or dial face 24 having analog markings thereon for indicating the measured parameter such as pressure, e.g., analog markings of 0, 100, 200, 300 and 400 psi in addition to other incremental measurement markings therebetween. The dial face may also include other indicia generally designated by reference number 26, for displaying any suitable type of indicia, such as alpha-numeric symbols, ISO symbols, markings, names, trademarks and the like.

The dial 22 further includes a pointer 28 movably attached to the dial 22 wherein the pointer is movable with respect to the analog markings on the dial face 24, as is generally known.

The illuminated liquid filled pressure gauge 10 further includes an electroluminescent assembly or device such as, for example, an electroluminescent lamp 30 that is positioned adjacent the dial 22 for transmitting light and illuminating selected portions of the dial 22, and more particularly for illuminating selected portions of the dial face 24. Advantageously, the electroluminescent lamp 30 is positioned to allow a user of the gauge 10 to be able to read a pressure measurement in low or adverse lighting conditions or other conditions where additional lighting would be advantageous.

The electroluminescent lamp 30 may comprise, for example, many small phosphor particles which light up when electrical energy is applied to them. Light is emitted when electrons are relaxed and return to their unexcited state. Electroluminescent lamps draw very little power and produce very little heat. They do not include filaments or mechanical parts, and are not susceptible to shock, vibration or catastrophic light failure. Unlike directional light sources such as LEDs and incandescent lights, electroluminescent lamps are lambertian, i.e., they have a uniformly illuminated surface which appears equally bright from all viewpoints of about 160 degrees on a flat surface. Furthermore, a 360 degree visibility is possible with a wraparound configuration. Any suitable type of electroluminescent material may be used as the electroluminescent lamp 30, such as sheets sold by Graphic Solutions under the designation H9000 Series Electroluminescent Lamps.

Another aspect of the invention includes a protective cover for enclosing the electroluminescent assembly or device, e.g., the electroluminescent lamp 30, to seal and protect the electroluminescent device from the liquid which fills the gauge 10. In one embodiment of the invention, the protective cover may include plastic laminate sheets 32, 34 that are provided on opposing faces of the electroluminescent lamp 30. The sheets 32, 34 may be made of a material such as, for example, vinyl, polycarbonate, or Lexan.

In one embodiment of the invention, the electroluminescent lamp 30 is positioned behind the dial 22, i.e., is positioned on an opposing side of the dial 22 from the dial face 24. In order to illuminate the dial face 24, the dial 22 may include translucent portions which permit transmission of light from the electroluminescent lamp 30, and non-translucent portions which block some or all of the light from the electroluminescent lamp 30. In one embodiment, the analog markings on the dial face 24 of the dial 22 are non-translucent, while the remainder of the dial face 24 is translucent. In this manner, when the electroluminescent lamp 30 is activated, the analog markings and numbers appear dark, while the remainder of the dial face 24 appears bright. This enables the analog markings which display, for example, the pressure measurements for the gauge 10, to be visible to a user in low or adverse lighting conditions. It will be appreciated that any other suitable type of pattern may be used, including non-translucent backgrounds with translucent markings, colored backgrounds with markings of different color(s), and the like. Furthermore, the indicia markings 26 that may be displayed on the dial face 24 may be, for example, non-translucent similar to the analog markings in order that the electroluminescent lamp 30 transmits light through the translucent portions of the dial 22 for illuminating the indicia markings 26.

The implementation described above and other implementations are within the scope of the following claims.

What is claimed is:

1. A liquid filled gauge, comprising:
a housing;
a lens cap attached to said housing;
a gauge diagnostic element contained at least partially within said housing;
a dial that includes a translucent portion and a non-translucent portion, said dial operatively connected to said gauge diagnostic element; and
an electroluminescent device positioned adjacent said dial for transmitting light through said translucent portion and illuminating said dial.

2. The liquid filled gauge of claim 1, further including a protective cover for enclosing said electroluminescent device to seal and protect the electroluminescent device from the liquid which fills the gauge.

3. The liquid filled gauge of claim 2, wherein said protective cover includes first and second laminate sheets on opposing faces of said electroluminescent device.

4. The liquid filled gauge of claim 1, wherein the dial includes a display face having a first area with analog markings and a second area without analog markings, said dial also including a pointer movably aligned with said analog markings.

5. The liquid filled gauge of claim 4, wherein said first area with analog markings makes up said non-translucent portion of said dial.

6. The liquid filled gauge of claim 5, wherein second area without analog markings makes up said translucent portion of said dial.

7. The liquid filled gauge of claim 4, wherein the display face also includes a third area with indicia markings, wherein said first area with analog markings and said third area with indicia markings combine to make up said non-translucent portion of said dial.

8. The liquid filled gauge of claim 1, wherein said gauge diagnostic element measures pressure.

9. The liquid filled gauge of claim 1, wherein said electroluminescent device includes an electroluminescent material.

10. An apparatus, comprising:
a sealed housing assembly containing a liquid;
a gauge diagnostic element contained in said housing assembly;
a dial operatively connected to said gauge diagnostic element, said dial visibly positioned within said sealed housing assembly; and
an electroluminescent device positioned adjacent said dial for illuminating at least a portion of said dial.

11. The apparatus of claim 10, wherein said dial includes a translucent portion and a non-translucent portion.

12. The apparatus of claim 11, wherein the dial includes a display face having a first area with analog markings and a second area without analog markings, said dial also including a pointer movably aligned with said analog markings.

13. The apparatus of claim 12, wherein said first area with analog markings makes up said non-translucent portion of said dial.

14. The apparatus of claim 13, wherein second area without analog markings makes up said translucent portion of said dial.

15. The apparatus of claim 10, further including first and second laminate sheets on opposing faces of said electroluminescent device for enclosing said electroluminescent device to seal and protect the electroluminescent device from said liquid contained in said housing assembly.

16. The apparatus of claim 10, wherein said gauge diagnostic element measures pressure.

17. A liquid filled pressure gauge, comprising:
a gauge housing;
a gauge lens attached to said gauge housing in order to seal the liquid within the gauge housing;
a gauge diagnostic system contained within said gauge housing for measuring and displaying a pressure measurement;
an electroluminescent lamp assembly positioned adjacent said gauge diagnostic system for illuminating the displayed pressure measurement.

18. The liquid filled pressure gauge of claim 17, wherein said electroluminescent lamp assembly includes an electroluminescent material.

19. The liquid filled pressure gauge of claim 17, wherein said gauge diagnostic element includes a dial that includes a translucent portion and a non-translucent portion, said electroluminescent lamp assembly transmitting a light through said translucent portion to illuminate the displayed pressure measurement.

20. The liquid filled pressure gauge of claim 17, further including a protective cover for enclosing said electroluminescent lamp assembly to seal and protect the electroluminescent lamp assembly from the liquid which fills the gauge housing.
